(19) United States
(12) Patent Application Publication
(10) Pub. No.: US 2026/0119272 A1
(43) Pub. Date: Apr. 30, 2026

(54) SCALING WORKER NODES BASED ON RESOURCE USAGESPREDICTED BY MACHINE LEARNING MODELS

(71) Applicant: Hewlett Packard Enterprise Development LP, Spring, TX (US)

(72) Inventors: Suporno Chaudhury, Bangalore (IN); Shikha Nagesh, Bangalore (IN)

(21) Appl. No.: 19/039,996

(22) Filed: Jan. 29, 2025

(30) Foreign Application Priority Data
Oct. 29, 2024 (IN) 202441082610

(51) Int. Cl. G06F 9/50; G06N 3/0442

(52) U.S. Cl. CPC G06F 9/5083; G06N 3/0442

(57) ABSTRACT

A technique includes accessing, for a given worker node of a collection of worker nodes associated with an application, a set of observed operating behavior metric values that are associated with the given worker node. The collection of worker nodes is associated with respective microservices of the application. The collection of worker nodes corresponds to an orchestrated container cluster. The technique includes applying a machine learning model to the set of observed operating behavior metrics to predict a future resource usage for the worker node. The technique includes initiating scaling of the given worker node based on the future resource usage.

### BACKGROUND

In one type of application architecture, an application may be monolithic and correspond to a single unit. In another type of application architecture, an application may be formed from multiple, autonomous parts called “microservices.” As compared to the monolithic architecture, the microservice architecture provides greater scalability, flexibility and improved manageability. Moreover, the microservice architecture may be better suited for cloud deployment of an application.

### BRIEF DESCRIPTION OF THE DRAWINGS

FIG. 1 is a block diagram of a computer network that includes a predictive scaling regulation architecture that predicts resource usages for worker nodes and scales the worker nodes based on the predicted resource usages, according to an example implementation.

FIG. 2 is a block diagram of a predictive scaling architecture that scales worker nodes based on resource usages that are predicted using an overfit bidirectional long short-term memory (LSTM) model, according to an example implementation.

FIG. 3 is a flow diagram depicting a technique to predict resource usages of a worker node using an overfit bidirectional LSTM model and vertically scale the worker node based on the predicted resource usages, according to an example implementation.

FIG. 4 is a flow diagram depicting a technique to horizontally scale a worker node based on a predicted resource usage, according to an example implementation.

FIG. 5 is a flow diagram depicting a technique to determine a container pod step size for horizontal autoscaling of a worker node, according to an example implementation.

FIG. 6 is a flow diagram depicting a technique to apply a machine learning model to predict a resource usage for a worker node that is associated with a microservice-based application and scale the worker node based on the predicted resource usage, according to an example implementation.

FIG. 7 is an illustration of hardware processor readable instructions that are stored on a non-transitory storage medium and when executed by a hardware processor, cause a scaling engine to apply a machine learning model to predict a resource usage for a worker node associated with a microservice-based application and vertically scale the worker node based on the predicted resource usage, according to an example implementation.

FIG. 8 is a block diagram of a system that includes a hardware processor to apply an overfit bidirectional LSTM model to predict a resource usage for a worker node associated with a microservice-based application and vertically scale the worker node based on the predicted resource usage, according to an example implementation.

### DETAILED DESCRIPTION

Unlike an application that has a monolithic design, a microservice-based application is decomposed into finer-grained components, or microservices, which can each be deployed and scaled independently. A microservice-based application may be deployed on an orchestrated container cluster (e.g., a KUBERNETES cluster or a DOCKER SWARM cluster). An orchestrated container cluster has worker nodes and a control plane. The control plane, in general, manages the lifecycles and workloads of containers that are hosted on the worker nodes.

In an example, worker nodes of an orchestrated container cluster provide respective microservices of a microservice-based application. Each worker node hosts one or multiple container pods, and each container pod corresponds to an instance of the microservice. An orchestrated container cluster may be hosted on a variety of computing environments, such as an edge computing environment, a private cloud, a public cloud, a hybrid cloud, or a combination thereof.

A worker node may be virtual (e.g., correspond to a virtual machine) or physical (e.g., correspond to a bare-metal environment). Regardless of whether a worker node is virtual or physical, the worker node has an associated set of resources, which support the workloads of the hosted microservice instances. In this context, a “workload” refers to an application process or a group of application processes operating under the same identity. A virtual worker node has associated virtual resource allocations, such as a number of virtual processing cores (e.g., virtual central processing unit (CPU) cores and/or virtual graphics processing unit (GPU) cores), an amount of virtual memory and an amount of virtual storage. A physical worker node has associated physical resource allocations, such as a number of physical processing cores, an amount of physical memory and an amount of physical storage.

A microservice performs an amount of work that corresponds to a “workload demand.” The workload demand may vary over time, due to any of a number of different reasons. In examples, the workload demand may vary due to an increasing number of end users as the popularity of the application increases, seasonal usage patterns, daily usage patterns and long-term usage trends, among other factors. The workload demands of respective microservices of a microservice application may vary differently with respect to each other over time.

The worker node has a corresponding capacity, which controls whether the worker node can adequately handle a given workload demand. The capacity has two dimensions: a vertical dimension that corresponds to the amount, or size, of resources that are allocated to the worker node; and a horizontal dimension that corresponds to the number of container pod replicas (corresponding to different microservice instances) that are hosted by the worker node. An appropriately-sized worker node capacity satisfies two competing goals. One goal in sizing a worker node's capacity is to ensure that the capacity is sufficient to meet certain Quality-of-Service (QoS) metrics for the application. For example, an insufficient capacity for a particular worker node may result in end users of the application experiencing long processing delays, or may result end users having their requests time out. Another goal in sizing a worker node's capacity is to ensure that the capacity is not over-sized, or overprovisioned, for purposes of limiting the application's operating costs.

Because a workload demand of a worker node varies over time, the regulation of the worker node's capacity is dynamic in nature, with the capacity being continuously scaled to track the workload demand. In this context, the “scaling” of a worker node's capacity refers to the capacity being changed so that the capacity is either increased (or “scaled up”) or decreased (or “scaled down”). In general, a worker node may be scaled vertically, horizontally or both vertically and horizontally to accommodate a changing workload demand.

Vertically scaling a worker node changes the size, or amount, of resources that are allocated to the worker node. Horizontally scaling a worker node changes the number of container pods (also called “container pod replicas”) that are hosted by the worker node. In an example of vertical scaling, the number of CPU cores and the size of a random access memory (RAM) allocated to a worker node are scaled up to accommodate an increased workload demand. In another example of vertical scaling, the number of CPU cores and the size of the RAM allocated to a worker node are scaled down to accommodate a decreased workload demand.

In an example of horizontal scaling, the number of container pods hosted by the worker node is scaled up to accommodate an increased workload demand. another example of horizontal scaling, the number of container pods hosted by the worker node is scaled down to accommodate a decreased workload demand.

In one approach, scaling may be reactive, which means that the capacity of a worker node is scaled based on the worker node's current workload demand. Reactive scaling encompasses both vertical and horizontal scaling. A challenge with reactive horizontal scaling is that there may be a significant scaling response delay (e.g., minutes) between the time that an increase in a worker node's workload demand is observed and the time that the number of container pods is increased to accommodate the increase. This scaling response delay may cause QoS issues (e.g., latency issues, such as dropped requests due to timeouts) for the end users of the application. A challenge with reactive vertical scaling is that the worker node is taken down to change the worker node's resource allocations, resulting in all instances of the corresponding microservice being temporarily unavailable.

In accordance with example implementations that are described herein, a proactive, predictive scaling architecture estimates, or predicts, resource usages of worker nodes for an upcoming forecast time period and regulates scaling of the worker nodes based on the predicted resource usages. In this context, a “predicted resource usage” refers to an estimated measure of a worker node capacity to satisfy the workload demand during the forecast period. A worker node capacity that satisfies a workload demand refers to a capacity that is not over-provisioned but is sufficient to meet performance criteria (e.g., QoS metric criteria). Assessing whether a given capacity is “over-provisioned” may be based on any of a number of metrics, such as whether the capacity is a certain percentage greater than the minimum capacity needed to meet the performance criteria.

In an example, the worker nodes are part of an orchestrated container cluster that hosts a microservice-based application. The worker nodes provide respective microservices of the application. Each worker node hosts one or multiple container pods that correspond to respective microservice instances. The predictive scaling architecture includes a predictive scaling engine that uses a machine learning model to predict resource usages for respective associated worker nodes over an upcoming forecast period, and the predictive scaling architecture scales the capacities of the worker nodes based on the predicted resource usages. In an example, the scaling may be vertical scaling. In another example, the scaling may be horizontal scaling. In another example, the scaling may be a combination of vertical and horizontal scaling. As further described herein, the predictive scaling architecture, in accordance with example implementations, also uses the predicted resource usages to determine container pod step sizes for purposes of horizontally autoscaling the worker nodes during the forecast period.

In accordance with example implementations, a performance metric service of the orchestrated container cluster's control plane reports data representing time-varying performance metric values (e.g., values corresponding to “kube metrics”) for the worker nodes. As described further herein, for each worker node, the predictive scaling architecture converts performance metric values for the worker node into feature vectors. The predictive scaling architecture, for each worker node, applies a machine learning model to the feature vectors for the worker node for purposes of determining one or multiple predicted resource usages (e.g., a number of CPU cores and/or a RAM size allocation size) over an upcoming forecast. In accordance with example implementations and as further described herein, the predictive scaling architecture uses an overfit, bidirectional long short-term memory (LSTM) model to determine the predicted resource usages.

Among the advantages of the predictive scaling architecture that is described herein, microservice availability is increased. Human involvement in scaling decisions is minimized. The predictive scaling architecture accommodates both regular and seasonal workload demand changes, and the predictive scaling architecture promptly and efficiently handles workload demand surges. The predictive scaling architecture has a relatively small resource footprint.

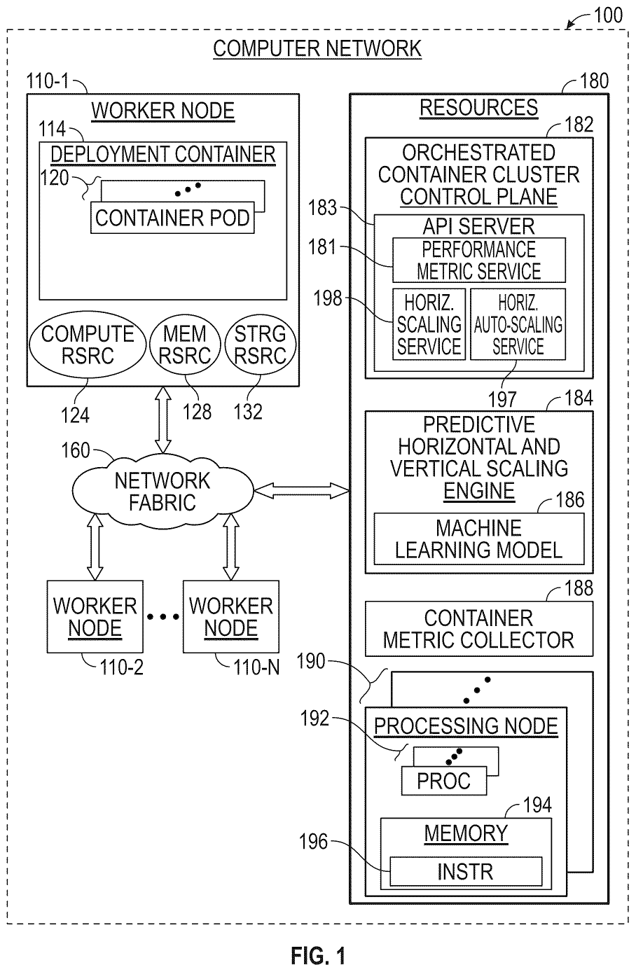

In a more specific example, FIG. 1 depicts a computer network 100 in accordance with some implementations. The computer network 100 hosts microservices of a microservice-based application. More specifically, in accordance with example implementations, the microservices are hosted by N worker nodes 110 (worker nodes 110-1, 110-2 and 110-N being specifically depicted in FIG. 1) of an orchestrated container cluster (e.g., a KUBERNETES cluster or a DOCKER SWARM cluster). In addition to the worker nodes 110, the orchestrated container cluster further includes a control plane 182. FIG. 1 depicts specific components of a particular worker node 110-1. The other worker nodes 110 may each have similar components to the depicted components of the worker node 110-1, in accordance with example implementations.

The worker nodes 110 may be associated a variety of different computing environments. A computing environment, in accordance with example implementations, may correspond to a private cloud, a public cloud, a hybrid cloud, an edge computing system or a combination of one or multiple of the foregoing environments. In the context that is used herein, a “cloud” refers to a computer system that is associated with resources that can be scaled up and down on demand.

In a more specific example, a particular computing environment is a private cloud that is managed by a business entity and has on-premise resources that are located in the business entity's private datacenter, are located in leased space of a co-location datacenter, or some combination thereof. In another example, a particular computing environment is a hybrid cloud that has on-premise resources that are managed by a public cloud operator. In another example, a particular computing environment is a public cloud. In another example, a particular computing environment corresponds to the network edge and provides network connectivity for edge devices as well as providing one or multiple other services (e.g., edge storage or edge compute services). In an example, all of the worker nodes 110 are located in the same private cloud. In an example, all of the worker nodes 110 are deployed in the same computing environment (e.g., all worker nodes 110 are deployed on a private cloud, or all worker nodes 110 are deployed on a public cloud). In another example, the worker nodes 110 may be deployed in multiple, different computing environments (e.g., some worker nodes 110 are deployed on a private cloud and other worker nodes 110 are deployed on a public cloud).

A given worker node 110 may be virtual or physical. In an example, all of the worker nodes 110 are virtual, and in another example, all of the worker nodes 110 are physical. In another example, some worker nodes 110 are virtual, and the remaining worker nodes 110 are physical.

A worker node 110 being “virtual” refers to the worker node 110 having virtual resources. In an example, the worker node 110-1 is virtual and has virtual compute resources 124 (e.g., virtual CPU cores and/or virtual GPU cores), virtual memory resources 128 (e.g., a virtual RAM) and virtual storage resources 132. In another example, a server (e.g., an enclosure-based server, such as a blade server; a rack-based server, such as a density line (DL) server; or a tower server) has physical compute, memory and storage resources that are abstracted by a hypervisor of the server, and a worker node 110 corresponds to a virtual machine that is hosted by the server.

A worker node 110 being “physical” refers to the worker node 110 having unabstracted access to physical resources. In an example, the worker node 110-1 is a physical node and has physical compute resources 124, physical memory resources 128 and physical storage resources 132. In examples, a physical worker node 110 corresponds to a server, such as the entire server or a bare-metal environment corresponding to certain physical resources of the server.

A worker node 110 may have resources other than compute, memory resources and storage resources. In an example, a worker node 110 has compute, memory and storage resources as well as network resources. In another example, a worker node 110 has compute and memory resources but does not have storage resources.

The worker nodes 110 are connected to each other and to the control plane 182 via network fabric 160. In accordance with example implementations, the network fabric 160 may be associated with one or multiple types of communication networks, such as (as examples) Fibre Channel networks, Compute Express Link (CXL) fabric, dedicated management networks, local area networks (LANs), wide area networks (WANs), global networks (e.g., the Internet), wireless networks, or any combination thereof.

In accordance with example implementations, the microservices of the application correspond to respective worker nodes 110, and each worker node 110 and runs in a respective deployment container that is allocated to and started on the worker node 110. As depicted in FIG. 1, a deployment container 114 of the worker node 110-1 has a collection of container pods 120. In an example, each container pod 120 within the deployment container 114 corresponds to an instance of the microservice. The container pods 120 may also be referred to as “container pod replicas.”

In accordance with example implementations, a predictive horizontal and vertical scaling engine 184 (called the “predictive scaling engine 184” herein) dynamically regulates both horizontal and vertical scaling of the worker nodes 110 to accommodate changing workload demands. For each worker node 110, the predictive scaling engine 184 applies a machine learning model 186 to a collection of feature vectors that are derived from observed performance metric data for the worker node 110. The application of the machine learning model 186 to the collection of feature vectors for a particular worker node 110 provides one or multiple estimated, or predicted, future resource usages (called “predicted resource usages” or “associated predicted resource usages” herein) for the worker node 110 over an upcoming forecast period.

A predicted resource usage refers to an estimated measure of a worker node capacity to satisfy the workload demand during the forecast period. In an example, a predicted resource usage is an estimated average number of CPU cores for the worker node 110. In this manner, the predicted resource usage indicates a prediction that if the worker node 110 is equipped with the estimated average number of CPU cores during the forecast period, the worker node has a sufficient CPU capacity to handled the workload demand during the forecast period. As described further herein, the predictive scaling engine 184 derives a vertical size and a horizontal size for the worker node 110 based on the predicted resource usage. In another example, a predicted resource usage is an average RAM size for the worker node 110 for the forecast period. In another example, a predicted resource usage is an estimated storage usage (e.g., an average storage disk size) for the worker node 110 of the worker node 110 for the forecast period. As further described herein, if the determined vertical size (e.g., the number of allocated CPU cores) or horizontal size (e.g., the number of container pods) of a particular worker node 110 is not appropriate based on the predicted resource usage, then the predictive scaling engine 184 adjusts, or scales, the worker node's capacity. The scaling may be vertical scaling, horizontal scaling or a combination of vertical and horizontal scaling.

The predicted resource usage may take on one of a number of different forms. In an example, the predicted resource usage is an estimated average resource usage of a worker node over a forecast period, which is projected to be sufficient to satisfy a workload demand. In another example, the predicted resource usage is an estimated maximum resource usage of a worker node over the forecast period, which is projected to be sufficient to satisfy a workload demand. In another example, the predicted resource usage is an estimated median resource usage of a worker node over the forecast period, which is projected to be sufficient to satisfy a workload demand.

In an example, the predictive scaling engine 184, for each worker node 110, determines multiple predicted resource usages (e.g., a combination of a predicted average number of CPU cores, a predicted average RAM allocation size, or a combination of a predicted average number of CPU cores, a predicted average RAM allocation size, and a predicted average storage allocation size). The predictive scaling engine 184 regulates the vertical and horizontal scaling of each worker node 110 based on the multiple predicated resource usages.

The forecast period, in accordance with example implementations, begins at or near the current time and extends forward in time by a predetermined time interval (e.g., a number of hours, a number of days, a week or another period). In an example, the predictive scaling engine 184 determines predicted resource usages for the worker nodes 110 pursuant to a schedule (e.g., periodic schedule having a period of a certain number of hours, days, a week or multiple weeks) that has scheduling times that are separated by the forecast period. Therefore, for each scheduling time of the schedule, the predictive scaling engine 184 determines predicted resource usages for the worker nodes 110 for the upcoming forecast period, identifies any vertical and/or horizontal scaling changes for the worker nodes 110 based on the predicted resource usages, and makes the scaling changes.

In another example, the timing of the resource usage prediction is event-driven. For example, the predictive scaling engine 184 determines resource usage predictions in response to an observed application workload demand increasing at rate that exceeds a particular upper rate threshold. In another example, the predictive scaling engine 184 generates resource usage predictions in response to an observed application workload demand decreasing at rate that falls below a particular lower rate threshold. In another example, the predictive scaling engine 184 generates resource usage predictions according to a schedule that varies according to an expected seasonal demand. For example, the predictive scaling engine 184 generates resource usage predictions more often during periods of expected high workload demand and generates resource usage predictions less often during periods of expected lower workload demand. In another example, the predictive scaling engine 184 generates resource usage predictions at an interval that is based on an observed drift of the machine learning model 186. For example, the predictive scaling engine 184 generates usage predictions more often when a relatively higher drift is observed and generates usage predictions less often when a relatively lower drift is observed.

Vertically scaling a worker node 110 changes a resource allocation size (or “resource size”) of the worker node 110 to correspond to a predicted resource usage. As described further herein, the relationship between the resource allocation size and the predicted resource usage may depend on a number of factors, such as a cost effectiveness of the predictive scaling and a latency that is associated with the predictive scaling. In an example, vertically scaling a worker node 110 changes the number of compute resources (e.g., a number of CPU cores and/or, a number of GPU cores) allocated to the worker node 110. In an example, a worker node 110 is currently allocated 10 CPU cores, and the predictive scaling engine 184 predicts that during the forecast period (e.g., one week) an average allocation of 14 CPU cores of the worker node 110 is appropriate. Continuing the example, based on the predicted resource usage, the predictive scaling engine 184 vertically scales up the worker node 110 (e.g., vertically scales up the worker node 110 to have 16 CPU cores).

In another example, vertically scaling a worker node 110 changes an amount of RAM that is allocated to the worker node 110. In an example, worker node 110 is currently allocated a RAM size of 300 megabytes (MB), and the predictive scaling engine 184 predicts that during the forecast period, an average RAM allocation of 150 MB is appropriate for the worker node 110. Based on this predicted resource usage, the predictive scaling engine 184 vertically scales down the worker node 110 (e.g., vertically scales down the worker node 110 to have a capacity of 170 MB RAM).

In another example, vertically scaling a worker node 110 changes both the number of CPU cores allocated to the worker node 110 and the amount of RAM allocated to the worker node 110. In another example, vertically scaling a worker node 110 changes a storage size allocated to the worker node 110.

Vertically scaling a worker node 110, in accordance with example implementations, includes the predictive scaling engine 184 communicating with a control plane 182 of the orchestrated container cluster to stop the deployment container (e.g., deployment container 114) of the worker node 110. The predictive scaling engine 184 changes the allocation of resources allocated to the deployment container and then restarts the deployment container. In an example, this communication includes the predictive scaling engine 184 calling application programming interfaces (APIs) that are served by an API server 183 of the control plane 182, for purposes of stopping, starting and deploying containers.

Horizontally scaling a worker node 110 changes a number of container pods that are hosted by the worker node 110. As described further herein, the relationship between the number of container pods and the predicted resource usage may depend on a number of factors, such as a degree of load balancing among the container pods and the resource size (e.g., a size measured in terms of a number of CPU cores or a RAM allocation) of the worker node 110. If the predictive scaling engine 184 determines that the number of container pods derived from the predicted resource usage is different than the current number of container pods, then the predictive scaling engine 184 horizontally scales the worker node 110. As further described herein, for purposes of horizontally scaling a worker node 110, the predictive scaling engine 184 communicates with the API server 183 of the control plane 182 to change the number of container pod replicas of the worker node 110. In an example, the control plane 182 provides a horizontal scaling service 198 for purposes of changing the number of container pods of a worker node 110. In an example, the predictive scaling engine 184 communicates with the horizontal scaling service 198 by calling an API that is served by the API server 183.

In accordance with example implementations and as further described herein, the predictive scaling engine 184 may also regulate horizontal autoscaling step sizes for the worker nodes 110 based on the predicted resource usages. As further described herein, the predictive scaling engine 184 determines the autoscaling step size based on a predicted resource usage for the worker node 110. “Horizontal autoscaling,” in this context, refers to reactive scaling that is performed by the control plane 182 based on performance metrics of the worker node 110 and criteria that are defined in an autoscaling policy. In an example, the control plane 182 provides a horizontal autoscaling service 197 for this purpose. In an example, the predictive scaling engine 184 communicates with the horizontal autoscaling service 197 by calling an API that is served by the API server 183. In an example, the autoscaling policy includes a step size, which refers to an atomic unit of pods by which scaling occurs. In an example, for a step size of four pods for a particular worker node 110, the control plane 182 scales up and down four pods at a time. The control plane's decision of when to scale is controlled by criteria that are specified in the autoscaling policy. In an example, the autoscaling policy may specify an upper CPU consumption threshold so that when an observed CPU consumption of a worker node 110 surpasses the upper CPU consumption threshold, the control plane 182 increases the number of container pods by one step size. In another example, the autoscaling policy may specify a lower CPU consumption threshold so that when an observed CPU consumption of a worker node 110 decreases below the lower CPU consumption threshold, the control plane 182 decreases the number of container pods by one step size. In a similar manner, other thresholds and policy metrics may be specified to control the automatic, reactive horizontal autoscaling by the control plane 182.

In accordance with example implementations, a performance metric service 181 of the control plane 182 provides performance metric data for the worker nodes 110. In an example, a container metric collector 188 communicates with the performance metric service 181 by calling APIs that are served by the API server 183 for purposes of gathering performance metric values, which are used by the predictive scaling engine 184 to derive resource usage predictions. The predictive scaling engine 184, for each worker node 110, converts the performance metric values into a collection of feature vectors that correspond to a trailing moving, or sliding, time window. The predictive scaling engine 184, for each worker node 110 and for each forecast period, applies the machine learning model 186 to the collection of feature vectors for purposes of determining one or multiple predicted resource usages for the worker node 110. In accordance with some implementations, the application of the machine learning model 186 to a collection of feature vectors for a particular worker node 110 produces multiple predicted resource usages (e.g., a predicted average CPU usage and a predicted average RAM usage) for the worker node 110. In accordance with further implementations, the predictive scaling engine 184 includes multiple machine learning models 186 that correspond to different resource usage categories. For example, one machine learning model 186 predicts an average CPU usage, and another machine learning model 186 predicts an average RAM usage. In accordance with some implementations, each worker node 110 has an associated collection of one or multiple machine learning models 186 to provide the predicted resource usage(s) for the worker node 110.

In accordance with example implementations, the predictive scaling engine 184, the orchestrated container cluster control plane 182, and the container metric collector 188 are hosted on resources 180. In an example, the resources 180 correspond to a cloud, such as a public cloud, private cloud or hybrid cloud.

As used herein, an “engine,” such as predictive scaling engine 184, as well as other engines that are described herein, can refer to one or multiple circuits. For example, the circuits may be hardware processing circuits, which can include any or some combination of a microprocessor, a core of a multi-core microprocessor, a microcontroller, a programmable integrated circuit (e.g., a programmable logic device (PLD), such as a complex PLD (CPLD)), a programmable gate array (e.g., field programmable gate array (FPGA)), an application specific integrated circuit (ASIC), or another hardware processing circuit. In an example, the resources 180 include one or multiple processing nodes 190. A processing node 190 includes one or multiple hardware processors 192 and a memory 194. Instructions (e.g., instructions 196 stored in a memory 194) may be executed by one or multiple hardware processors 192 on one or multiple processing nodes 190 to cause the hardware processor(s) 192 to perform one or multiple functions for the predictive scaling engine 184, as described herein. In an example, multiple instances of the predictive scaling engine 184 may be associated with different worker nodes 110. In another example, the predictive scaling engine 184 may be a microservice-based application.

The memory 194 includes non-transitory storage media that may be formed from semiconductor storage devices, memristor-based storage devices, magnetic storage devices, phase change memory devices, a combination of devices or one or more of these storage technologies, and so forth. The memory 194 may represent a collection of memories of both volatile memory devices and non-volatile memory devices.

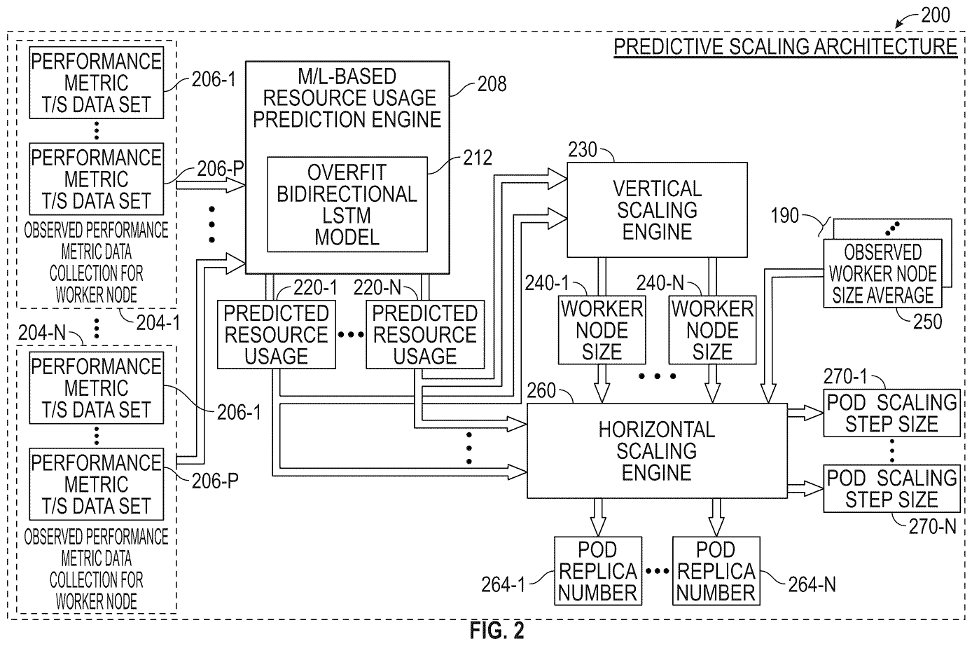

FIG. 2 depicts a predictive scaling architecture 200 in accordance with example implementations. In an example, the predictive scaling architecture 200 corresponds to the predictive scaling engine 184 of FIG. 1. Referring to FIG. 2, in accordance with example implementations, the predictive scaling architecture 200 includes a machine learning-based resource usage prediction engine 208 (called a “resource usage prediction engine 208” herein), a vertical scaling engine 230 and a horizontal scaling engine 260.

The resource usage prediction engine 208 accesses observed performance metric data for the worker nodes (e.g., the worker nodes 110 of FIG. 1) of an orchestrated container cluster. As depicted in FIG. 2, the observed performance metric data includes N observed performance metric data collections 204 (observed performance metric data collections 204-1 and 204-N being specifically depicted in FIG. 2) for N respective worker nodes. Each observed performance metric data collection 204 includes P performance metric time series datasets 206 (performance metric time series datasets 206-1 and 206-P being specifically depicted in FIG. 2) for the associated worker node. A performance metric time series dataset 206 characterizes a different attribute, or characteristic, of the worker node and corresponds to a segment of a time series captured by a trailing moving, or sliding, time window. In the context used herein, a “time series” refers to a sequence of successive values.

In a more specific example, the orchestrated container cluster is a KUBENETES cluster, and a performance metric service (e.g., the performance metric service 181 of FIG. 1) of the orchestrated container cluster's control plane (e.g., the control plane 182 of FIG. 1) provides performance metrics called “kube metrics” that are associated with different layers of the orchestrated container cluster. The kube metrics, in general, describe observed operating behaviors of components of the orchestrated container cluster. In an example, each of the P performance metric time series datasets 206 corresponds to a different kube metric. In general, a given performance metric time series dataset 206 represents an attribute that is considered relevant to determining a predicted resource usage and may be an attribute related to an operating behavior of a particular worker node or represent an attribute related to an operating behavior of the orchestrated container cluster. In examples, the performance metric time series datasets 206 characterize resource consumption, network load, response times, intra-container characteristics, different resources in-use, as well as other performance-related aspects of the worker nodes and the orchestrated container cluster.

In an example, a performance metric time series dataset 206 may represent an attribute of a top cluster layer of the orchestrated container cluster. In examples, a performance metric time series dataset 206 represents a utilization of resources of the orchestrated container cluster, such as a cluster memory utilization, a cluster CPU utilization and a cluster disk utilization. In other examples, a performance metric time series dataset 206 represent a number of pods of a container cluster, which are running and a number of pods that are unavailable.

In another example, a performance metric time series dataset 206 may represent an attribute of a control plane of the orchestrated container cluster. In examples, performance metric time series datasets 206 represent respective numbers of API calls to different resources of the orchestrated container cluster. In another example, a performance metric time series dataset 206 represents a total latency of a particular container resource. In another example, a performance metric time series dataset 206 represents whether the orchestrated container cluster has a leader node.

In another example, a performance metric time series dataset 206 represents an attribute of a specific worker node. In an example, a performance metric time series dataset 206 represents a latency for scheduling a load on a worker node. In another example, a performance metric time series dataset 206 represents a number of containers that are currently running in a particular worker node. In another example, a performance metric time series dataset 206 represents a latency for a particular runtime operation on a particular worker node. In other examples, a performance metric time series dataset 206 may represent network traffic associated with a worker node, CPU utilization of a worker node, memory utilization of a worker node, disk utilization of a worker node and available disk space of a worker node.

In another examples, a performance metric time series dataset 206 represents an attribute associated with a particular container pod of a specific worker node. In examples, a performance metric time series dataset 206 may represent the number of requests to an application process running in a container pod or a utilization of a container pod. In other examples, a performance metric time series dataset 206 may represent an attribute associated with an application process that is running inside a container pod, such as, for example, a rate of requests to the process or an error rate of the process.

The resource usage prediction engine 208, for each observed performance metric data collection 204, converts the data collection 204 into a set of feature vectors and applies a machine learning model 212 to the set of feature vectors for purposes of determining one or multiple predicted resource usages 220 for each worker node. FIG. 2 depicts N exemplary predicted resource usages 220 (predicted resource usages 220-1 and 220-N being specifically depicted in FIG. 2), which correspond to respective worker nodes.

In an example, for a particular worker node, each feature vector corresponds to a particular timestamp and is a tuple of elements corresponding to different performance metrics. In an example, the set of feature vectors used to derive a predicted resource usage 220 corresponds to different timestamps within a trailing sliding time window. In an example, the elements of a particular feature vector correspond to a sampling of all the performance metrics. In another example, the elements of a particular feature vector correspond to a sampling of a lesser subset of the entire set of performance metrics. In accordance with example implementations, the particular performance metrics that are considered features as well as the weights that are applied to the considered performance metrics are derived in association with the training of the machine learning model 212.

As depicted in FIG. 2, in accordance with example implementations, the machine learning model 212 is an overfit, bidirectional long short-term (LSTM) model. An LSTM model is a specific type of neural network model. A neural network model is a sophisticated computational model inspired by the human brain's interconnected neural cells. A neural network model is adept at learning from and interpreting complex patterns within data, which allows machines using such a model to make decisions, recognize patterns, and perform tasks in a way that mimics human intelligence. A neural network model includes layers of nodes, or “neurons,” and each layer is responsible for extracting a different level of abstraction of the data.

An LSTM model may be more specifically categorized as being a specific neural network model called a “recurrent neural network,” or “RNN,” model. An RNN model excels at learning from sequences of data, such as time series, language, or anything where the current step is dependent on the previous steps. An LSTM model is an RNN model with the addition of a special gating mechanism that allows the LSTM model to discard information over long sequences, which means that an LSTM model is particularly powerful for tasks that rely on memory over time.

The “bidirectional” aspect of the overfit bidirectional LSTM model 212 means that the model 212 is an LSTM that processes data in both forward and backward directions. By processing data in both forward and backward directions, the model has context from both predicted future points (i.e., the forward direction) and from past points (i.e., the backward direction) in the sequence.

The overfit bidirectional LSTM model 212 is trained using training data that has associated correct output, or labels. The training of the overfit LSTM model 212 teaches the model 212 to recognize patterns in feature vectors and generate the correct resource usage predictions. In an example, a particular worker node has an observed performance metric time series history and an observed average CPU resource usage history. The observed performance metric time series history and the observed average CPU usage history may be used as training data as the correct resource usage predictions and corresponding feature vector sets may be derived for different forecast periods. After being trained, the overfit bidirectional LSTM model 212 may then predict resource usages for new data. The overfit bidirectional model 212 may be continually retrained, as further described herein.

The “overfit” aspect of the overfit bidirectional LSTM model 212, in the context that is used herein, means that the model 212 more accurately predicts resource usages from training data than the model 212 predicts resource usages from new data. In general, regularization techniques are often employed to avoid overfitting a machine learning model so that the model is more generalized and does not consider every pattern in new data to be similar to the patterns in its training data. However, in accordance with example implementations, the bidirectional LSTM model 212 is deliberately overfit (as denoted by the “overfit” modifier), which allows the model 212 to make relatively accurate predictions on new data that is similar to the training data. If high variance and high bias are already present in the data due to niche patterns, the mean square error can be brought down to the irreducible errors leading to very high accuracy with low training data requirement. Moreover, due to the overfitting, the bidirectional LSTM model 212 has a relatively small resource footprint, which increases its portability for different computing environments and use cases.

An “overfit” machine learning model has a relatively large loss gap, or difference, between a validation loss for the model and a training loss for the machine learning model. A “validation loss” refers to a measure of the performance of the model on a dataset other than a training dataset. A “training loss” refers to a measure of the performance of the model on a training dataset. The loss gap may be characterized by a ratio of the training loss to the validation loss (e.g., a ratio that is the training loss divided by the validation loss). In an example, a machine learning model is considered to be “overfit,” in the context that is used herein, due to the model having an associated training loss-to-validation-loss ratio that is less than 0.05 (e.g., a ratio that is the training loss divided by the validation loss and is less than 0.05). It is noted that a training loss-to-validation loss ratio of 1.0 indicates no overfitting. An “overfit” machine learning model may also be characterized as being a machine learning model that has a relatively large number of weights-to-number-of-training samples ratio (e.g., a ratio that is the number of weights divided by the number of training samples). In an example, a machine learning model is considered to be “overfit,” in the context that is used herein, due to the model having a number of weights-to-number-of-training samples ratio that is greater than 1.0 (e.g., a ratio that is the number of weights divided by the number of training samples and is greater than 1.0).

Although a single overfit bidirectional LSTM model 212 is depicted in FIG. 2, in accordance with further implementations, the resource usage prediction engine 208 may have or use multiple overfit bidirectional LSTM models 212. In an example, the resource usage prediction engine 208 may use an overfit bidirectional LSTM model 212 to predict CPU core averages for the worker nodes, and the resource usage prediction engine 208 may use another overfit bidirectional LSTM model 212 to predict average RAM allocations for the worker nodes. In another example, the resource usage prediction engine 208 may have one or multiple overfit bidirectional LSTM models 212 for each worker node.

As depicted in FIG. 2, in accordance with example implementations, the vertical scaling engine 230 receives data representing the predicted resource usages 220 and generates respective worker node sizes 240 (worker node sizes 240-1 and 240-N being specifically depicted in FIG. 2). In examples, a worker node size 240 may be a number of CPU cores, a number of GPU cores, a RAM allocation size, a disk allocation size or other resource allocation for a worker node. Although a single worker node size 240 per worker node is depicted in FIG. 2, in accordance with further implementations, a worker node may have multiple associated sizes (e.g., a number of CPU cores and a RAM size allocation).

In an example, the vertical scaling engine 230 determines a CPU size (called “WN_SIZECPU”) for a worker node as follows:

$${WN\_SIZE}_{CPU} = STEP ( {PREDICTED\_USAGE}_{CPU} \cdot β \cdot ( \frac{{CE}_{CPU} - {LAT}_{CPU}}{LB} ) )$$

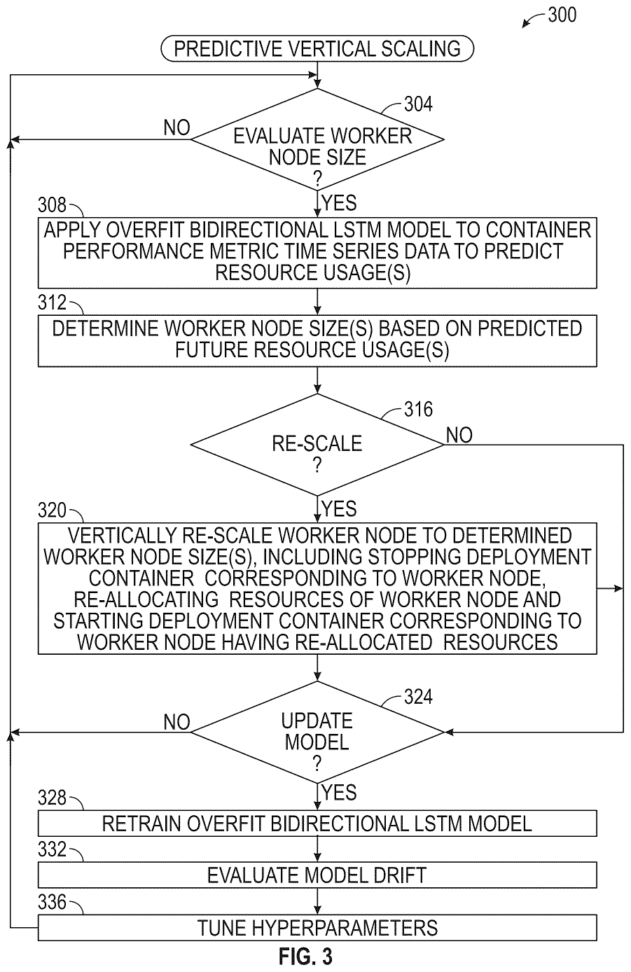

In this equation, the WN_SIZECPU CPU size is an integer (e.g., “10” representing 10 CPU cores for the worker node), and “STEP( )” represents a step function, which converts a real number into an integer. In an example, the STEP( ) function rounds down a real number to the closest integer. Also in this equation, “PREDICTED_USAGECPU” represents a predicted number (e.g., an average number) of CPU cores for the worker node for satisfying the workload demand during the forecast period, and “B” represents a scalar. The overfit bidirectional model 212 provides the PREDICTED_USAGECPU number of CPU scores. “CECPU” is a cost efficiency score, which represents an effectiveness of the PREDICTED_USAGECPU number of CPU cores as a predictor for the WN_SIZECPU CPU size. “LATCPU” represents a latency score representing the processing latency of the overfit bidirectional LSTM model 212 in deriving the PREDICTED_USAGECPU number of CPU cores. “LB” represents the degree of load balancing among the container pods of the worker node. FIG. 3, which is described further herein, describes an exemplary technique performed by the vertical scaling engine 230 for purposes of regulating the vertical scaling of a worker node, in accordance with example implementations.

Still referring to FIG. 2, in another example, the vertical scaling engine 230 determines a RAM size (called “WN_SIZERAM”) for a worker node as follows:

$${WN\_SIZE}_{RAM} = STEP ( {PREDICTED\_USAGE}_{RAM} \cdot β \cdot ( \frac{{CE}_{CPU} - {LAT}_{RAM}}{LB} ) )$$

In this equation, WN_SIZERAM RAM size is an integer (e.g., “100” representing a 100 MB RAM size for the worker node). “PREDICTED_USAGERAM” represents a predicted RAM allocation (e.g., an average RAM allocation) for the worker node for satisfying the workload demand during the forecast period. The PREDICTED_USAGERAM RAM allocation is provided by the overfit bidirectional LSTM model 212. “CERAM” is a cost efficiency score, which represents an effectiveness of the PREDICTED_USAGERAM RAM size as a predictor for the WN_SIZERAM RAM size. “LATRAM” represents a latency score representing the processing latency of the overfit bidirectional LSTM model 212 in determining the PREDICTED_USAGERAM RAM size.

The horizontal scaling engine 260 determines, for each worker node, data representing a pod replica number 264 (pod replica numbers 264-1 and 264-N being specifically depicted in FIG. 2). The pod replica number 264 is the number of container pods for the worker node. In an example, the horizontal scaling engine 260 determines a pod replica size (called “POD_REPLICA_SIZE”) as follows:

$$POD\_REPLICA \_SIZE = ( \frac{PREDICTED\_USAGE \cdot LB}{WN\_SIZE} )$$

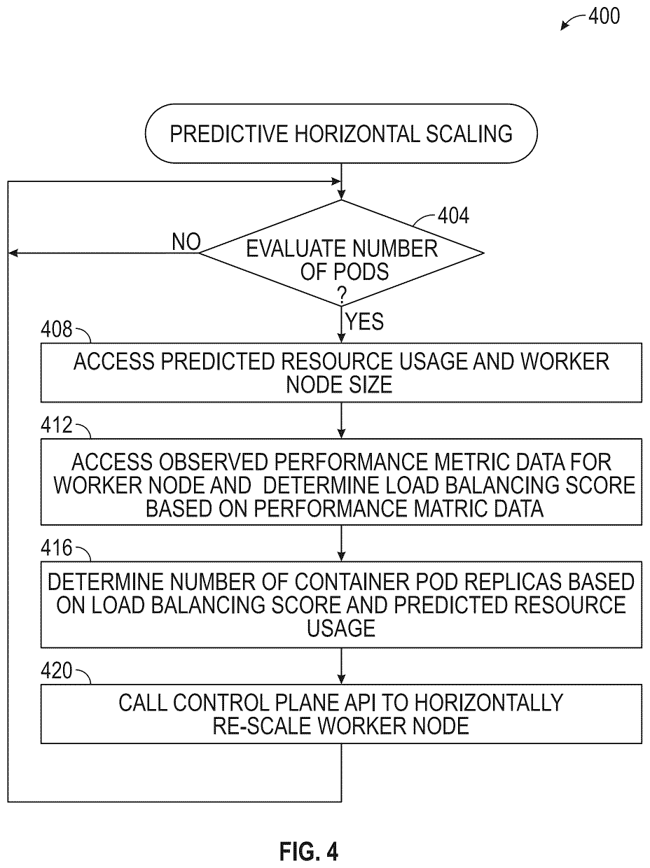

In this equation, the POD_REPLICA_SIZE pod replica size is an integer (e.g., “12” to represent 12 container pods for the worker node). In an example, “PREDICTED_USAGE” and “WN_SIZE” in the equation above are the PREDICTED_USAGECPU predicted number of CPU cores and the WN_SIZECPU CPU size, respectively. In another example, “PREDICTED_USAGE” and “WN_SIZE” in the equation above are the PREDICTED_USAGERAM predicted RAM allocation and the WN_SIZERAM RAM size, respectively. FIG. 4, which is described further herein, describes an exemplary technique performed by the horizontal scaling engine 260 for purposes of regulating the horizontal scaling of a worker node, in accordance with example implementations.

Still referring to FIG. 2, in accordance with example implementations, the horizontal scaling engine 260 also determines, for each worker node, data representing a pod scaling step size 270 (pod scaling step sizes 270-1 and 270-N being specifically depicted in FIG. 2). The pod scaling step size 270 is an atomic scaling step size used by the control plane for horizontal autoscaling of the worker nodes during the forecast period. The horizontal scaling engine 260 determines the pod scaling step size 270 for a given worker node based on a worker node size 240 that is predicted for the worker node and an observed worker node size average 250 for the worker node. In an example, the horizontal scaling engine 260 determines the pod scaling step size (called “H_STEP_CPU”) for a particular worker node as follows:

$$H\_STEP \_CPU = STEP ( k \cdot \frac{{PREDICTED\_USAGE}_{CPU}}{AVG\_CPN {\_NO}_{OBSERVED}} )$$

In this equation, the H_STEP_CPU pod scaling step size is an integer (e.g., “2” to represent a pod scaling step size of two container pods for the worker node), and “k” represents a scalar value. Also in this equation, “AVG_CPU_NOOBSERVED” represents an observed average number of CPU cores for the worker node. In an example, the AVG_CPU_NOOBSERVED observed average number of CPU cores is a moving average. In a more specific example, the AVG_CPU_NOOBSERVED observed average number of CPU cores is a simple moving average of the number of CPU cores allocated to the worker node over a trailing sliding time window. In another example, the AVG_CPU_NOOBSERVED observed average number of CPU cores is an exponential moving average of the number of CPU cores allocated to the worker node over a trailing sliding time window and placing more weight on more recently observed CPU core numbers.

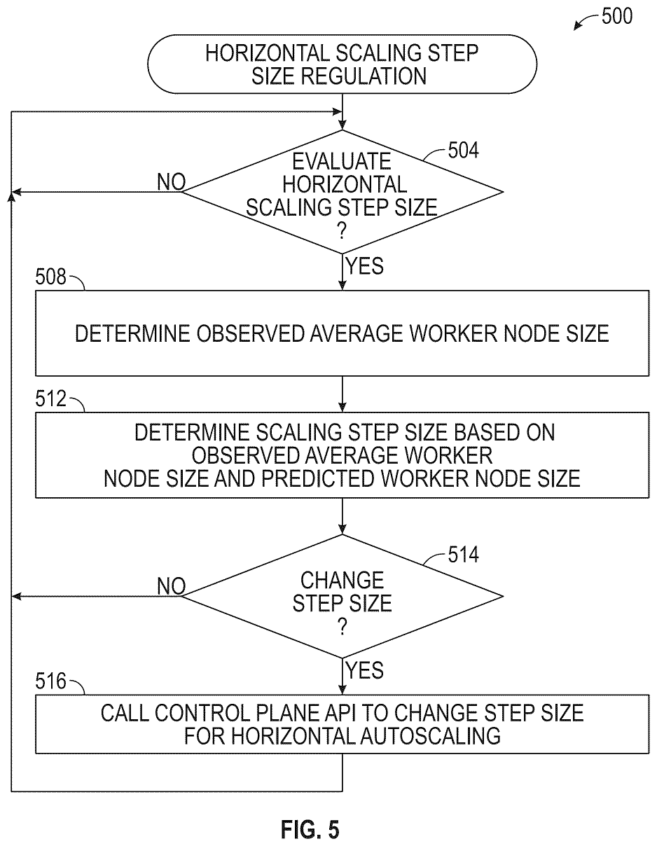

In another example, the horizontal scaling engine 260 may determine a pod scaling step size based on a ratio of the PREDICTED_USAGERAM predicted RAM allocation and an observed RAM allocation (e.g., a simple moving average or an exponential moving average) determined over a trailing sliding time window. FIG. 5, which is described further herein, describes an exemplary technique performed by the horizontal scaling engine 260 for purposes of determining the pod scaling step size, in accordance with example implementations.

FIG. 3 depicts a technique 300 to regulate vertical scaling of a worker node of an orchestrated container cluster, according to example implementations. The technique 300 may be performed by a machine learning-based resource usage prediction engine and a vertical scaling engine, such as the resource usage prediction engine 208 and the vertical scaling engine 230, respectively, of FIG. 2.

Referring to FIG. 3, in accordance with example implementations, the technique 300 includes determining (decision block 304) whether to evaluate the worker node size. In an example, the worker node's allocated resources may be evaluated pursuant to a schedule, such as once a week. In another example, decision block 304 may involve applying one or multiple other criteria other than time-based criteria for purposes of determining whether the worker node size is to be evaluated. For example, decision block 304 may include determining to evaluate a worker node based on a more recent scaling history for the worker node. For example, the resources of a given worker node may be evaluated more frequently responsive to the time rate at which the resources of the worker node have recently been changed. In this manner, relatively more stable resource allocations may result in longer times between resource evaluations, and vice versa.

If, pursuant to decision block 304, a determination is made to evaluate the worker node size, then, pursuant to block 308, the technique 300 includes applying an overfit bidirectional LSTM model to performance metric time series data for the worker node for purposes of predicting one or multiple resource usages for the worker node over the upcoming forecast period. For example, a predicted resource usage may be an estimated average number of CPU cores for a worker node. In another example, a predicted resource usage may be an estimated RAM allocation for a worker node. In another example, a predicted resource usage may be an estimated storage size for a worker node.

Pursuant to block 312, the technique 300 includes determining one or multiple worker node sizes based on the predicted future resource usage(s). In an example, block 312 includes determining a number of compute resources for the worker node, such as a number of CPU cores, a number of GPU cores, or a combination of a number of CPU cores and GPU cores. In another example, block 312 includes determining a memory resource allocation for the worker node. In an example, the memory allocation may be a RAM allocation size for the worker node. In another example, block 312 includes determining a storage capacity allocation for the worker node.

The technique 300 includes, pursuant to decision block 316, determining whether to vertically re-scale the worker node. In an example, decision block 316 includes comparing the worker node size(s) determined in block 312 to the current worker node size(s). In an example, if a worker node size (e.g., a predicted number of CPU cores) determined in block 312 is different than the corresponding worker node size (e.g., the current number of CPU cores), then worker node is vertically re-scaled. In another example, the re-scaling decision is based on a particular comparison criterion (e.g., vertically re-scale if the predicted worker size corresponds to a ten percent or greater deviation from the current worker node size). In another example, determining whether to vertically scale up is based on one comparison criterion (e.g., vertically scale up if the predicted worker size is at least a ten percent or greater deviation from the current worker node size) and determining whether to vertically scale down is based on a different criterion (e.g., vertically scale down if the predicted worker size is at least a twenty percent deviation from the current worker node size).

Regardless of the particular criterion or criteria used, if, pursuant to decision block 316, a decision is made to vertically scale the worker node, then, pursuant to block 320, then technique 300 includes vertically re-scaling the worker node to the determined worker node size(s). The vertical re-scaling includes, in accordance with example implementations, temporarily shutting down the port associated with the worker node. For example, in accordance with some implementations, the vertical re-scaling includes stopping the container corresponding to the worker node, re-allocating resources of the worker node and starting a container corresponding to the worker node having the re-allocated resources. In another example, vertically re-scaling the worker node includes patching the worker node while the worker node remains running.

The technique 300 includes, pursuant to decision block 324, determining whether to update the overfit bidirectional LSTM model. In an example, decision block 324 includes determining whether an update is scheduled. In an example, the vertical re-scaling may be evaluated one time per week, and model updates coincide with this schedule. In this manner, a model update is performed after each vertical re-scaling. In another example, the model is updated at a different frequency than the vertical re-scaling. In an example, the model is updated every other time that vertical re-scaling occurs. In other examples, one or multiple other criteria may be applied for purposes of determining whether to perform updating of the model.

Regardless of whether the worker node was vertically re-scaled, the technique 300 includes, pursuant to block 324 determining whether to update the overfit bidirectional LSTM model. In an example, a policy may be to update the overfit bidirectional LSTM model once ever forecast period (e.g., once every week). In another example, a policy may be to update the overfit bidirectional LSTM model if observed QoE metrics for the application are not being met. In another example, a policy may be to update the overfit bidirectional LSTM model every other forecast period. Regardless of the policy that is applied, if a determination is made, pursuant to decision block 324 to update the overfit bidirectional LSTM model, then then, as depicted in block 328, the overfit bidirectional LSTM model is retrained. Pursuant to block 332 after the retraining of the overfit bidirectional LSTM mode, a model drift is evaluated, and based on the evaluated model drift, one or multiple hyperparameters may then be tuned, pursuant to block 336. At the conclusion of the model update, control then returns to decision block 304.

FIG. 4 depicts a technique 400 to horizontally scale a worker node. The technique 400 may be performed by a horizontal scaling engine, such as the horizontal scaling engine 260 of FIG. 2.

Referring to FIG. 4, the technique 400 includes determining, pursuant to decision block 404, whether to evaluate the number of container pods of the worker node. In accordance with example implementations, decision block 404 may include determining whether the horizontal scaling is to occur pursuant to a schedule. In an example, the horizontal scaling may occur daily. In another example, the horizontal scaling may have a frequency that coincides with the frequency of the vertical scaling. In another example, the determination of whether horizontal scaling should be performed may be triggered by an event, such as, for example, a QoS parameter not meeting a predefined threshold.

If, pursuant to decision block 404, the horizontal scaling is to be performed, then, pursuant to block 408, the technique 400 includes accessing a predicted resource usage and the current worker node size for the worker node. Moreover, pursuant to block 412, the technique 400 includes accessing observed performance metric data for the worker node and determining a load balancing score based on the observed performance metric data. Pursuant to block 416, the technique 400 includes determining the number of container pod replicas based on the load balancing score and the predicted resource usage. Pursuant to block 420, the technique 400 includes calling a control plane API to horizontally re-scale the worker node. In an example, the control plane API corresponds to an API provided by an API server (e.g., the API server 183 of FIG. 1) of a control plane for the orchestrated container cluster and corresponds to a horizontal scaling service (e.g., the horizontal scaling service 198 of FIG. 1) provided by the control plane.

FIG. 5 depicts a technique 500 to regulate a horizontal scaling step used in horizontal autoscaling. The technique 500 may be preformed by a horizontal scaling engine, such as the horizontal scaling engine 260 of FIG. 2.

Referring to FIG. 5, the technique 500 includes determining, pursuant to decision block 504, whether the horizontal scaling step size should be evaluated. In an example, decision block 504 may be performed pursuant to a schedule. In another example, the horizontal scaling step size evaluation coincides with the horizontal scaling pod replica number evaluation described above in connection with FIG. 4. In another example, decision block 504 is a function of the rate at which horizontal autoscaling is currently being performed.

If horizontal scaling step size is to be evaluated, then, pursuant to block 508, the technique 500 includes determining an observed average worker node size. In an example, determining the observed average worker node size may be based on worker node sizes observed over a trailing sliding time window. In an example, the observed average worker node size is a simple moving average. In another example, the observed average worker node size is an exponential moving average. In an example, the observed average worker node size is an average number of CPU cores of the worker node. In another example, the observed average worker node size is an average RAM size of the worker node.

Pursuant to block 512, the technique 500 includes determining the horizontal scaling step size based on the observed average worker node size and the predicated worker node size. Pursuant to decision to block 514, the technique 500 includes determining whether horizontal scaling step is to be changed. In an example, if the horizontal scaling step size determined in block 512 is different than the current horizontal scaling step size, then the horizontal scaling step size is changed. In another example, the decision of whether or not to change the horizontal scaling step size is based on a comparison (e.g., a ratio or difference) of the horizontal scaling step determined in block 512 and the current horizontal scaling step size. If the horizontal scaling step size is not to be changed, then control returns to decision block 504.

If the horizontal scaling step size is to be changed, then pursuant to block 516, the technique 500 includes calling a control plane API to change the step size for the horizontal autoscaling. In an example, the control plane API corresponds to an API provided by an API server (e.g., the API server 183 of FIG. 1) of a control plane for the orchestrated container cluster and corresponds to a horizontal autoscaling service (e.g., the horizontal autoscaling service 197 of FIG. 1) that is provided by the control plane.

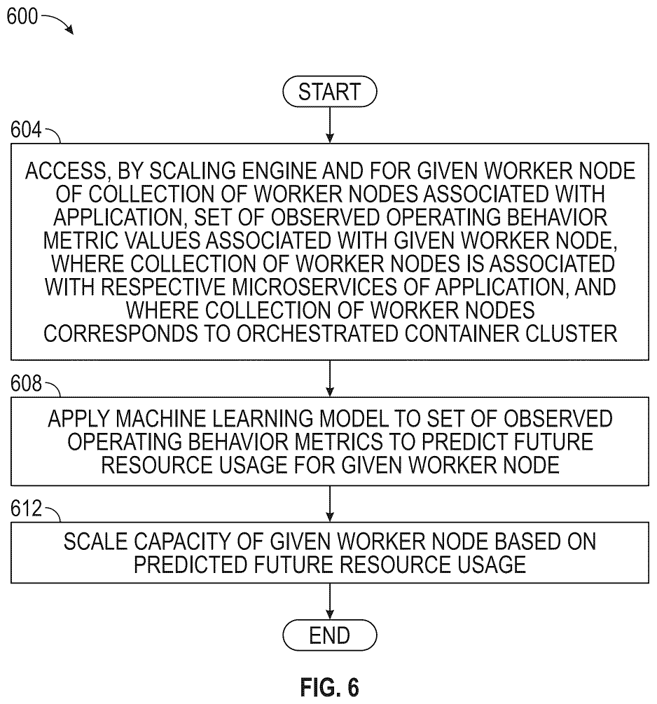

Referring to FIG. 6, in accordance with example implementations, a technique 600 includes accessing (block 604), by a scaling engine and for a given worker node of a collection of worker nodes associated with an application, a set of observed operating behavior metric values associated with the given worker node. The collection of worker nodes is associated with respective microservices of the application. The collection of worker nodes corresponds to an orchestrated container cluster. In an example, the orchestrated container cluster is a KUBERNETES cluster. In another example, the orchestrated container cluster is a DOCKER SWARM cluster. In an example, the worker nodes are virtual nodes (e.g., virtual machines). In another example, the worker nodes are physical nodes (e.g., physical, or actual, servers). In another example, the worker nodes are a combination of virtual nodes and physical nodes.

In an example, the operating behavior metric values represent performance-related criteria for the worker nodes. In an example, an observed operating behavior metric is a kube metric. In another example, an observed operating behavior metric is an attribute specific to a worker node or an attribute related to an orchestrated container cluster. In an example, the observed operating behavior metric characterizes a resource consumption, a network load, a response time, an intra-container characteristic, as well as other performance-related aspects of the worker nodes.

In an example, an observed operating behavior metric represents a utilization of resources of an orchestrated container cluster. In an example, an observed operating behavior metric represents a cluster memory utilization. In another example, an observed operating behavior metric represents a cluster CPU utilization. In another example, an observed operating behavior metric represents a cluster disk utilization. In other examples, an observed operating behavior metric may be a number of pods of a container cluster, which are running, or a number of pods that are unavailable.

In another example, an observed operating behavior metric represents a number of API calls to different resources of the orchestrated container cluster. In another example, an observed operating behavior metric represents a total latency of a particular container resource. In another example, an observed operating behavior metric represents whether the orchestrated container cluster has a leader node. In another example, an observed operating behavior metric represents a latency for scheduling a load on a worker node. In another example, an observed operating behavior metric represents a number of containers that are currently running in a particular worker node. In another example, an observed operating behavior metric represents a latency for a particular runtime operation on a particular worker node. In another example, an observed operating behavior metric represents network traffic associated with a worker node, a CPU utilization of a worker node, a memory utilization of a worker node, a disk utilization of a worker node or an available disk space for a worker node.

In another example, an observed operating behavior metric represents an attribute associated with a particular container pod of a particular worker node. In another example, an observed operating behavior metric represents the number of requests to an application process running in a container pod or a utilization of a container pod. In another example, an observed operating behavior metric represents an attribute associated with an application process that is running inside a container pod such as, for example, a rate of requests to the process or an error rate of the process.

The technique 600 includes applying (block 608) a machine learning model to the set of observed operating behavior metrics to predict a future resource usage for the worker node. In an example, the machine learning model is a recurrent neural network (RNN) model. In another example, the machine learning model is a long short-term memory (LSTM) model. In another example, the machine learning model is a bidirectional LSTM model. In another example, the machine learning model is an overfit bidirectional LSTM model.

In an example, the future resource usage is a predicted average number of CPU cores for the given worker node to satisfy a workload demand for the worker node over a forecast period. In another example, the future resource usage is a predicted average memory size allocation for the given worker node to satisfy a workload demand for the given worker node over the forecast period.

In accordance with example implementations, the technique 600 includes resource scaling (block 612) the given worker node based on the future resource usage. In an example, the scaling is vertical scaling. In another example, the scaling is horizontal scaling. In another example, the scaling is both vertical scaling and horizontal scaling. In an example, the scaling includes changing a size of the given worker node. In an example, changing the size of the given worker node includes increasing or decreasing a number of compute resources (e.g., CPU cores and/or GPU cores) allocated to the given worker node. In another example, changing the size of the given worker node includes increasing or decreasing a memory allocation (e.g., a RAM allocation) of the given worker node. In an example, changing the size of the worker node include increasing or decreasing an amount of storage allocated to the given worker node. In an example, horizontally scaling the worker node incudes changing a number of container pods that are hosted by the given worker node.

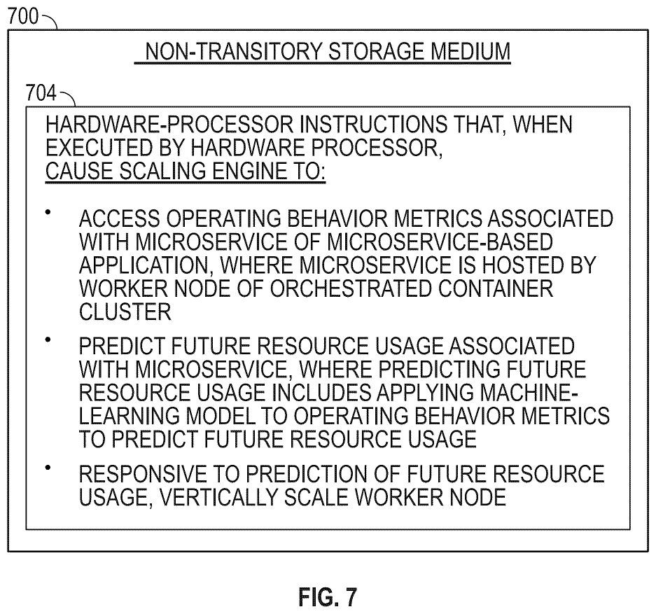

Referring to FIG. 7, in accordance with example implementations, a non-transitory storage medium 700 stores hardware processor-readable instructions 704 that, when executed by a hardware processor, cause a scaling engine to access operating behavior metrics associated with a microservice of a microservice-based application. The microservice is hosted by a worker node of an orchestrated container cluster. In an example, the scaling engine is formed by one or multiple CPU cores executing CPU-readable instructions. In an example, the hardware processor includes one or multiple CPU cores.

In an example, the scaling engine is associated with a public cloud. In an example, the scaling engine is associated with a private cloud. In another example, the scaling engine is associated with a hybrid cloud. In another example, the scaling engine is associated with a private non-cloud computing environment. In an example, the worker node provides multiple instances of the microservice. In example, the worker node includes multiple container pods, and each container pods provides an instance of the microservice.

In an example, the operating behavior metrics are performance metric time series associated with the worker node. In an example, the operating behavior metrics are kube metrics that are reported by a control plane of the orchestrated container cluster.

The instructions 704, when executed by the hardware processor, further cause the scaling engine to predict a future resource usage that is associated with the microservice. Predicting the future resource usage includes applying a machine learning model to the operating behavior metrics to predict the future resource usage. In an example, the machine learning model is an RNN model. In another example, the machine learning model is an LSTM model. In another example, the machine learning model is a bidirectional LSTM model. In another example, the machine learning model is an overfit bidirectional LSTM model.

In an example, the hardware processor converts operating behavior metric values into feature vectors and applies the machine learning model to the values to predict the future resource usage. In an example, the future resource usage is a predicted average number of CPU cores for the worker node to satisfy a workload demand for the worker node over a forecast period. In another example, the future resource usage is a predicted average memory size allocation for the worker node to satisfy a workload demand for the worker node over the forecast period.

The instructions 704, when executed by the hardware processor, further cause the scaling engine to, responsive to the prediction of the future resource usage, vertically scale resources that are associated with the worker node. In an example, vertically scaling the resources includes stopping a deployment container associated with the worker node, changing a resource allocation of the deployment container and restarting the deployment container. In an example, the vertical scaling includes changing a size of the worker node. In an example, changing the size of the worker node includes increasing or decreasing a number of compute resources (e.g., CPU cores and/or GPU cores) allocated to the worker node. In another example, changing the size of the worker node includes increasing or decreasing a memory allocation (e.g., a RAM allocation) of the worker node. In an example, changing the size of the worker node include increasing or decreasing an amount of storage allocated to the worker node.

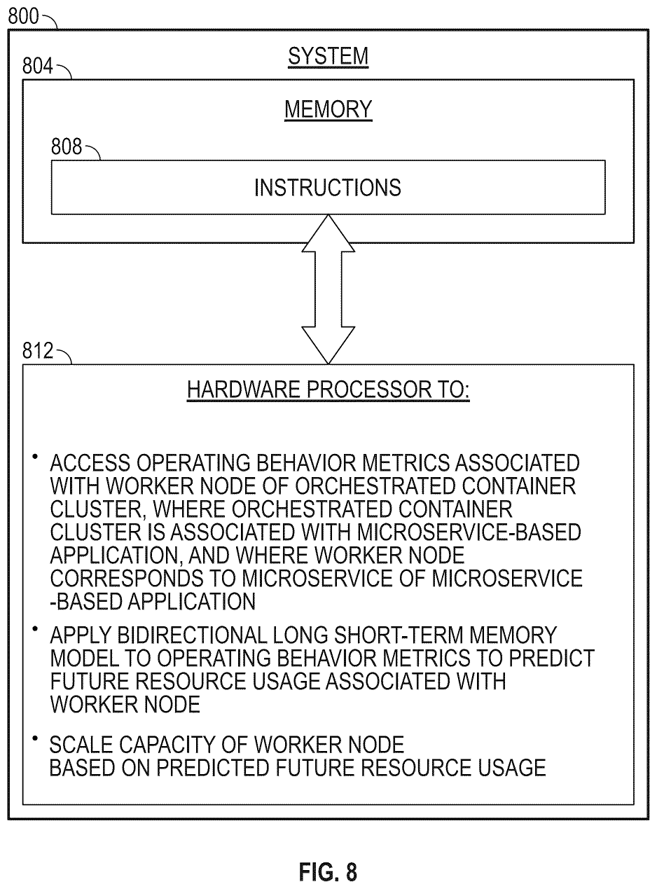

Referring to FIG. 8, in accordance with example implementations, a system 800 includes a memory 804 and a hardware processor 812. In an example, the system 800 is hosted on a public cloud. In an example, the system 800 is hosted on a private cloud. In another example, the system 800 is hosted on a hybrid cloud. In another example, the system 800 is hosted on a private non-cloud computing environment. In an example, the hardware processor 812 includes one or multiple CPU cores. In an example, the worker node provides multiple instances of the microservice. In example, the worker node includes multiple container pods, and each container pods provides an instance of the microservice.

The memory 804 stores hardware processor-readable instructions 808. The hardware processor 812 executes the instructions 808 to cause the hardware processor to access operating behavior metrics that are associated with a worker node of an orchestrated container cluster. The orchestrated container cluster is associated with a microservice-based application. The worker node corresponds to a microservice of the microservice-based application. In an example, the worker node provides multiple instances of the corresponding microservice. In example, the worker node includes multiple container pods, and each container pods provides an instance of the corresponding microservice. In an example, the orchestrated container cluster is a KUBERNETES cluster. In another example, the orchestrated container cluster is a DOCKER SWARM cluster.

The instructions 808, when executed by the hardware processor 812, further cause the hardware processor 812 to apply an LSTM model to the operating behavior metrics to predict a future resource usage associated with the worker node. In an example, the bidirectional LSTM model is an overfit model. In an example, the future resource usage is a predicted average number of CPU cores for the given worker node to satisfy a workload demand for the worker node over a forecast period. In another example, the future resource usage is a predicted average memory size allocation for the given worker node to satisfy a workload demand for the given worker node over the forecast period. In another example, the future resource usage is a predicted storage size allocation for the given worker node to satisfy a workload demand for the given worker node over the forecast period.

The instructions 808, when executed by the hardware processor 812, further cause the hardware processor 812 to scale resources that are associated with the worker node based on the future resource usage. In an example, the scaling is vertical scaling. In another example, the scaling is horizontal scaling. In another example, the scaling is both vertical scaling and horizontal scaling. In an example, the scaling includes changing a size of the worker node. In an example, changing the size of the worker node includes increasing or decreasing a number of compute resources (e.g., CPU cores and/or GPU cores) allocated to the worker node. In another example, changing the size of the worker node includes increasing or decreasing a memory allocation (e.g., a RAM allocation) of the worker node. In an example, changing the size of the worker node include increasing or decreasing an amount of storage allocated to the given worker node. In an example, horizontally scaling the worker node incudes changing a number of container pods that are hosted by the given worker node.

In accordance with example implementations, initiating the resource scaling includes initiating vertical scaling of the worker node based on the future resource usage. Among the potential benefits, microservice availability is increased; human involvement in scaling decisions is minimized; worker nodes are both vertically and horizontally scaled; regular and seasonal workload fluctuations are accommodated; the scaling infrastructure is resource light and portable; and workload demand surges are handled promptly and efficiently.

In accordance with example implementations, the vertical scaling includes scaling at least one of a number of CPU cores allocated to the worker node or a memory size allocated to the worker node. Among the potential benefits, microservice availability is increased; human involvement in scaling decisions is minimized; worker nodes are both vertically and horizontally scaled; regular and seasonal workload fluctuations are accommodated; the scaling infrastructure is resource light and portable; and workload demand surges are handled promptly and efficiently.

In accordance with example implementations, vertically scaling the given worker node includes determining a size of a resource allocated to the given worker node based on a cost effectiveness score associated with the machine learning model. Among the potential benefits, microservice availability is increased; human involvement in scaling decisions is minimized; worker nodes are both vertically and horizontally scaled; regular and seasonal workload fluctuations are accommodated; the scaling infrastructure is resource light and portable; and workload demand surges are handled promptly and efficiently.

In accordance with example implementations, vertically scaling the given worker node includes determining a size of the resource allocated to the given worker node based on a latency score associated with the machine learning model. Among the potential benefits, microservice availability is increased; human involvement in scaling decisions is minimized; worker nodes are both vertically and horizontally scaled; regular and seasonal workload fluctuations are accommodated; the scaling infrastructure is resource light and portable; and workload demand surges are handled promptly and efficiently.

In accordance with example implementations, vertically scaling the given worker node includes determining a size of the resource allocated to the given worker node based on a degree of load balancing associated with the given worker node. Among the potential benefits, microservice availability is increased; human involvement in scaling decisions is minimized; worker nodes are both vertically and horizontally scaled; regular and seasonal workload fluctuations are accommodated; the scaling infrastructure is resource light and portable; and workload demand surges are handled promptly and efficiently.

In accordance with example implementations, initiating the resource scaling includes horizontally scaling the worker node based on the future resource usage. Among the potential benefits, microservice availability is increased; human involvement in scaling decisions is minimized; worker nodes are both vertically and horizontally scaled; regular and seasonal workload fluctuations are accommodated; the scaling infrastructure is resource light and portable; and workload demand surges are handled promptly and efficiently.

In accordance with example implementations, horizontally scaling the worker node includes determining a given number of container pods for the worker node based on the future resource usage; and changing a current number of container pods of the worker node to the given number of container pods. Among the potential benefits, microservice availability is increased; human involvement in scaling decisions is minimized; worker nodes are both vertically and horizontally scaled; regular and seasonal workload fluctuations are accommodated; the scaling infrastructure is resource light and portable; and workload demand surges are handled promptly and efficiently.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
accessing, by a scaling engine and for a given worker node of a collection of worker nodes associated with an application, a set of observed operating behavior metric values associated with the given worker node, wherein the collection of worker nodes is associated with respective microservices of the application, and wherein the collection of worker nodes corresponds to an orchestrated container cluster;
applying, by the scaling engine, a machine learning model to the set of observed operating behavior metrics to predict a future resource usage for the worker node; and
initiating, by the scaling engine, scaling of the given worker node based on the future resource usage.

2. The method of claim 1, wherein initiating the scaling comprises initiating vertical scaling of the worker node based on the future resource usage.

3. The method of claim 2, wherein the vertical scaling comprises scaling at least one of a number of central processing unit (CPU) cores allocated to the worker node or a memory size allocated to the worker node.

4. The method of claim 2, wherein the vertical scaling comprises:
determining a size of a resource allocated to the given worker node based on a cost effectiveness score associated with the machine learning model.

5. The method of claim 2, wherein the vertical scaling comprises:
determining a size of a resource allocated to the given worker node based on a latency score associated with the machine learning model.

6. The method of claim 2, wherein the vertical scaling comprises:
determining a size of a resource allocated to the given worker node based on a degree of load balancing associated with the given worker node.

7. The method of claim 1, wherein initiating the scaling comprises initiating horizontal scaling of the worker node based on the future resource usage.

8. The method of claim 7, wherein the horizontal scaling comprises:
determining a given number of container pods for the worker node based on the future resource usage; and
changing a current number of container pods of the worker node to the given number of container pods.

9. The method of claim 7, wherein the horizontal scaling comprises:
determining a given number of container pods for the worker node based on the future resource usage, a load balancing associated with a current number of container pods associated with the worker node and a resource size associated with the worker node; and
changing the current number of container pods of the worker node to the given number of container pods.

10. The method of claim 1, wherein initiating the scaling comprises:
vertically scaling the worker node, wherein vertically scaling the worker node comprises predicting a future number of central processing unit (CPU) cores for the worker node based on the future resource usage; and
horizontally scaling the worker node, wherein horizontally scaling the worker node comprises:
determining a predicted average number of CPU cores for the worker node based on the future number of central CPU cores;
determining an observed average number of CPU cores for the worker node; and
determining a horizontal scaling step size based on the predicted average number of CPU cores and the observed average number of CPU cores.

11. The method of claim 10, wherein determining the observed average number of CPU cores comprises determining an observed exponential moving average number of CPU cores of the worker node.

12. The method of claim 1, wherein initiating the scaling comprises:
vertically scaling the worker node, wherein vertically scaling the worker node comprises predicting a future memory size for the worker node based on the future resource usage; and
horizontally scaling the worker node, wherein horizontally scaling the worker node comprises:
determining a predicted average memory size for the worker node based on the future memory size;
determining an observed average memory size for the worker node; and
determining a horizontal scaling step size based on the predicted average memory size and the observed average memory size.

13. The method of claim 12, wherein determining the observed average memory size comprises determining an observed exponential moving average of a memory size of the worker node.

14. The method of claim 1, wherein applying the machine learning model comprises applying an overfit bidirectional long short-term memory model to the set of operating behavior metrics to predict the future resource usage.

15. A non-transitory storage medium that stores hardware processor readable instructions that, when executed by a hardware processor, cause a scaling engine to:
access operating behavior metrics associated with a microservice of a microservice-based application, wherein the microservice is hosted by a worker node of an orchestrated container cluster;
predict a future resource usage associated with the microservice, wherein predicting the future resource usage comprises applying a machine learning model to the operating behavior metrics to predict the future resource usage; and
responsive to the prediction of the future resource usage, vertically scale resources associated with the worker node.

16. The storage medium of claim 15, wherein the instructions, when executed by the scaling engine, further cause the scaling engine to:
stop a container corresponding to the worker node;
re-allocate resources assigned to the worker node based on the future resource usage; and
responsive to the re-allocation, start a container corresponding to the worker node.

17. The storage medium of claim 15, wherein the instructions, when executed by the scaling engine, further cause the scaling engine to apply a bidirectional long short-term memory model to the set of operating behavior metrics to predict the future resource usage.

18. A system comprising:
a memory to store hardware processor-readable instructions; and
a hardware processor to execute the instructions to cause the hardware processor to:
access operating behavior metrics associated with a worker node of an orchestrated container cluster, wherein the orchestrated container cluster is associated with a microservice-based application, and wherein the worker node corresponds to a microservice of the microservice-based application;
apply a bidirectional long short-term memory model to the operating behavior metrics to predict a future resource usage associated with the worker node; and
scale resources associated with the worker node based on the future resource usage.

19. The system of claim 18, wherein the hardware processor to further execute the instructions to:
determine a given number of container pod replicas for the worker node based on the future resource usage; and
communicate with an application programming interface (API) server of a control plane associated with the orchestrated container cluster to change a current number of container pod replicas for the worker node to the given number of container pod replicas.

20. The system of claim 18, wherein the hardware processor to further execute the instructions to:
determine a given allocation of resources for the worker node based on the future resource usage; and
communicate with an application programming interface (API) server of a control plane associated with the orchestrated container cluster to change a current allocation of resources to the given allocation of resources.
